(19) United States
(12) Patent Application Publication
(10) Pub. No.: US 2025/0326092 A1
(43) Pub. Date: Oct. 23, 2025

(54) POWERED RATCHET TOOL WITH DEBRIS BARRIER

(71) Applicant: MILWAUKEE ELECTRIC TOOL CORPORATION, Brookfield, WI (US)

(72) Inventors: Kyle A. Marten, Plymouth, WI (US); Jordan P. Gilsinger, Sussex, WI (US); Jacob P. Schneider, Cedarburg, WI (US)

(21) Appl. No.: 19/184,805

(22) Filed: Apr. 21, 2025

Related U.S. Application Data
(60) Provisional application No. 63/636,527, filed on Apr. 19, 2024.

(51) Int. Cl. B25B 21/00; B25F 5/02

(52) U.S. Cl. CPC B25B 21/004; B25F 5/02

(57) ABSTRACT

A powered ratchet tool includes a housing and a motor disposed within the housing. The motor has an output shaft rotatable about a first axis. The powered ratchet tool further includes a ratchet mechanism operably coupled to the output shaft of the motor to be driven by the motor. The ratchet mechanism has a yoke supported by the housing for reciprocation about a second axis perpendicular to the first axis. Moreover, the powered ratchet tool includes a barrier assembly pivotably disposed between the housing and the yoke, and an output drive configured to receive a tool element. The barrier assembly is configured to seal a space defined between the housing and the yoke. The output drive is coupled to the yoke of the ratchet mechanism for rotation about the second axis.

### CROSS-REFERENCE TO RELATED APPLICATIONS

This application claims priority to U.S. Provisional Patent Application No. 63/636,527, filed Apr. 19, 2024, the entire contents of which is incorporated herein by reference.

### FIELD

The present disclosure relates to power tools, and more particularly to powered ratchet tools.

### BACKGROUND

Powered ratchet tools may be driven in a forward direction or an opposite direction to apply torque to a fastener for tightening and loosening operations. Powered ratchet tools are typically powered by an electrical source, such as a DC battery, a conventional AC source, or pressurized air.

### SUMMARY

The present disclosure provides, in one aspect, a powered ratchet tool including a housing and a motor disposed within the housing. The motor includes an output shaft rotatable about a first axis. The powered ratchet tool further includes a ratchet mechanism operably coupled to the output shaft of the motor to be driven by the motor. The ratchet mechanism includes a yoke supported by the housing for reciprocation about a second axis perpendicular to the first axis. Also, the powered ratchet tool includes a barrier assembly pivotably disposed between the housing and the yoke. The barrier assembly is configured to seal a space defined between the housing and the yoke. Moreover, the powered ratchet tool includes an output drive configured to receive a tool element. The output drive is coupled to yoke of the ratchet mechanism for rotation about the second axis.

The present disclosure provides, in another aspect, a powered ratchet tool including a housing defining a longitudinal axis, a motor disposed within the housing, and a ratchet mechanism operably coupled to the motor. The ratchet mechanism includes a yoke rotatable about a second axis perpendicular to the longitudinal axis when driven by the motor. The powered ratchet tool further includes an output drive extending through the housing to be coupled to the yoke for co-rotation and a rotational member coupled to the output drive. The rotational member is rotatable between a first position, in which the output drive co-rotates with the yoke in a first direction, and a second position, in which the output drive co-rotates with the yoke in a second direction opposite the first direction. Also, the powered ratchet tool includes a first groove defined within the housing. The first groove is configured to provide access to the rotational member from a first side of the housing to rotate the rotational member. Moreover, the powered ratchet tool includes a second groove defined within the housing. The second groove is configured to provide access to the rotational member from a second side of the housing opposite the first side to rotate the rotational member.

The present disclosure provides, in another aspect, a powered ratchet tool including a housing, a motor disposed within the housing, and a ratchet mechanism operably coupled to the motor. The ratchet mechanism has a yoke supported by the housing for reciprocation about a second axis perpendicular to the first axis. The powered ratchet tool further includes an output drive extending through the housing to be coupled to the yoke for co-rotation and a rotational member coupled to the output drive. The rotational member is rotatable between a first position, in which the output drive co-rotates with the yoke in a first direction, and a second position, in which the output drive co-rotates with the yoke in a second direction opposite the first direction. Moreover, the powered ratchet tool includes a lever pivotably coupled to the rotational member and configured to be rotated to thereby rotate the rotational member between the first position and the second position.

### BRIEF DESCRIPTION OF DRAWINGS

FIG. 1 is a top view of a powered ratchet tool according to an embodiment of the present disclosure.

FIG. 2 is an enlarged perspective view of the powered ratchet tool of FIG. 1.

FIG. 3 is an enlarged perspective view of a yoke disassembled from a head of the powered ratchet tool of FIG. 1.

FIG. 4A is a cross-sectional view of the head of FIG. 3, the head at a first stroke position.

FIG. 4B is a cross-sectional view of the head of FIG. 2, the head at a second stroke position.

FIG. 5 is an enlarged perspective view of a head of a powered ratchet tool according to an embodiment of the present disclosure.

FIG. 6 is an enlarged perspective view of the head of FIG. 5 with a tool element.

FIG. 7 is an enlarged perspective view of a head of a powered ratchet tool according to an embodiment of the present disclosure, the powered ratchet tool including a lever.

FIG. 8 is an enlarged perspective view of the head of FIG. 8, the lever pivoted upwards relative to the head.

FIG. 9 is a perspective view of a drive bushing according to an embodiment of the present disclosure.

FIG. 10 is a front view of the drive bushing of FIG. 9.

FIG. 11 is a cross-sectional view of a drive bushing according to an embodiment of the present disclosure.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

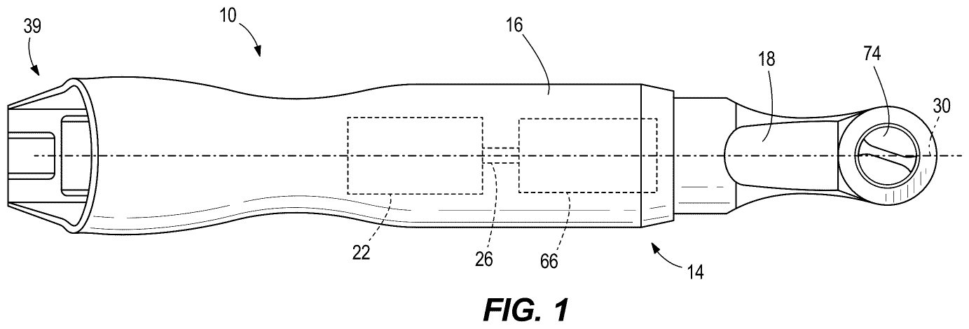

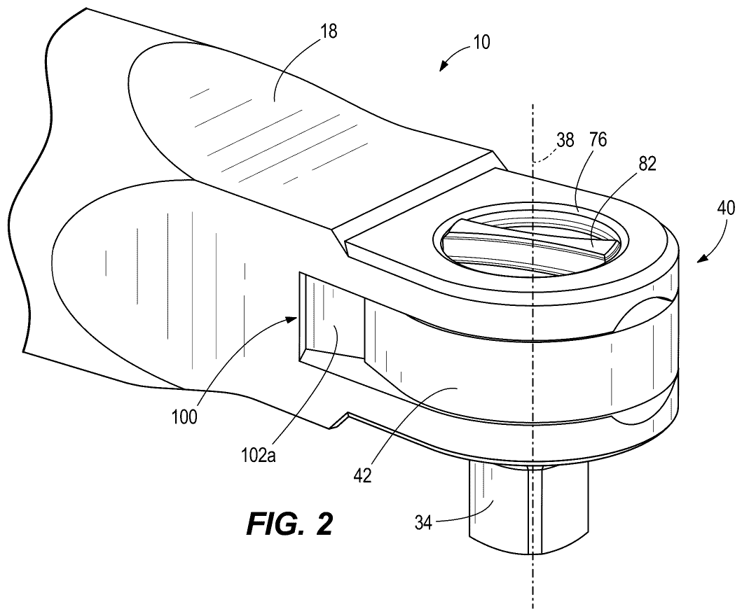

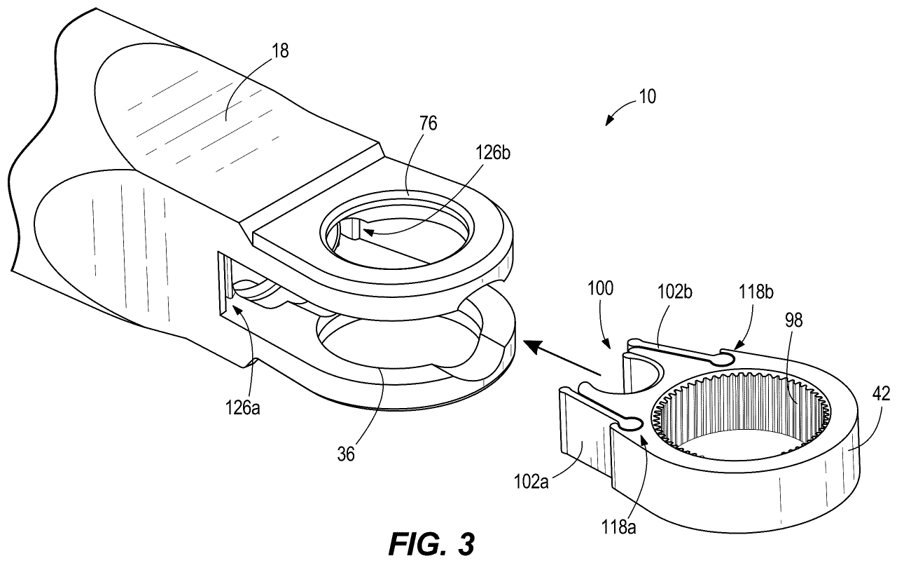

With reference to FIG. 1, a powered ratchet tool 10 in accordance with an embodiment of the disclosure includes a housing 14 having a handle housing 16 and a head or yoke housing 18 coupled to and extending from the handle housing 16. The handle housing 16 serves as a handle configured to be grasped by a user during operation. The ratchet tool 10 further includes a motor 22 that is supported within the housing 14, more specifically the handle housing 16. The motor 22 has an output shaft 26 rotatable about a first axis 30 and is configured to provide torque to an output drive 34 (FIG. 2) supported by the yoke housing 18 for rotation about a second axis 38 (FIG. 2) oriented perpendicular to the first axis 30. More specifically, the output drive 34 extends through a first opening 36 (FIG. 3) defined within the yoke housing 18. The motor 22 is preferably a brushless DC motor. In some embodiments, the motor 22 is a surface permanent magnet (SPM) motor including a stator, a rotor, and permanent magnets affixed to or embedded in an exterior surface of the rotor. In other embodiments, the motor 22 is an outer rotor motor, having a rotor that surrounds and rotates about a stator. In other embodiments, other types of motors may be used.

The powered ratchet tool 10 also includes a battery pack (not shown) received by a battery receptacle 39 formed in the handle housing 16 opposite the yoke housing 18. The battery receptacle 39 electrically connects the battery pack to the motor 22 (via suitable electrical and electronic components, such as a PCBA containing MOSFETs, IGBTs, or the like). The battery pack may be a 12-volt power tool battery pack that includes three lithium-ion battery cells. Alternatively, the battery pack may include fewer or more battery cells to yield any of a number of different output voltages (e.g., 14.4 volts, 18 volts, etc.). Additionally, or alternatively, the battery cells may include chemistries other than lithium-ion such as, for example, nickel cadmium, nickel metal-hydride, or the like. The ratchet tool 10 also includes an actuator (not shown) for controlling operation of the ratchet tool 10 (e.g., to energize/de-energize the motor 22). In some embodiments, the actuator may be a push-button that can be depressed into the handle housing 16 to energize the motor 22. As such, the push button may extend from the handle housing 16 in the same direction as the output drive 34. In other embodiments, the actuator may be other types of actuating mechanisms (e.g., slide switch).

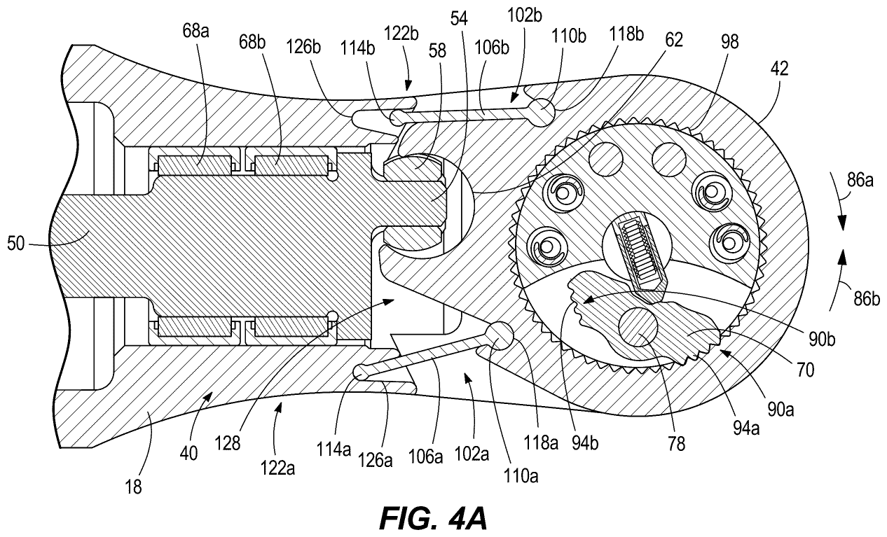

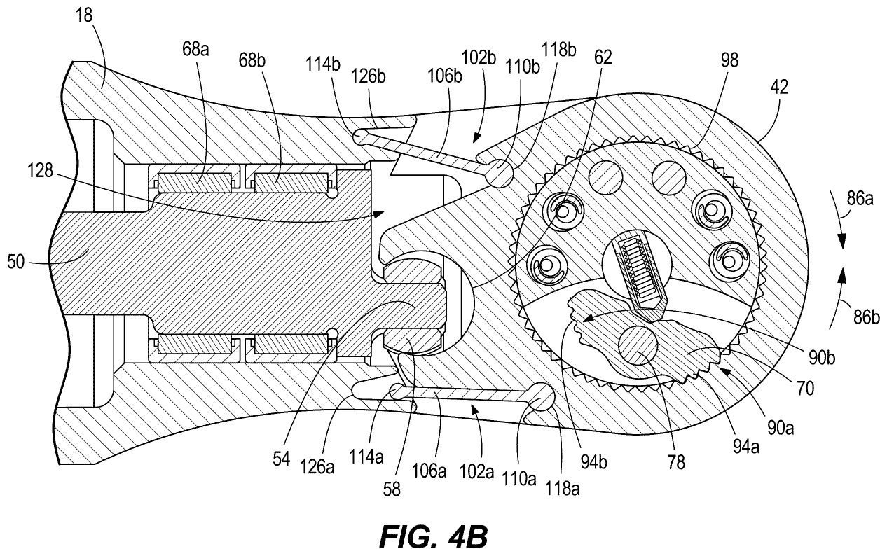

With reference to FIGS. 2-4B, the powered ratchet tool 10 further includes ratchet mechanism 40 having a yoke 42 supported by the yoke housing 18, a crankshaft 50 with an eccentric member 54, and a drive bushing 58 arranged on the eccentric member 54. The output drive 34 extends through the yoke 42. Also, the yoke 42 has a recess 62 in which the drive bushing 58 is arranged. The crankshaft 50 of the ratchet mechanism 40 is operably coupled to the output shaft 26 of the motor 22 via a drive assembly 66 (FIG. 1). Also, a pair of bearings 68a, 68b are provided within the yoke housing 18 to rotatably support the crankshaft 50. As explained further in detail below, when the crankshaft 50 is rotated, the drive bushing 58 pivots the yoke 42 in a reciprocating manner to drive the output drive 34.

Moreover, the ratchet mechanism 40 includes a pawl 70 and a forward/reverse switch in the form of a rotational member 74 (FIG. 1) arranged within a second opening 76 defined in the yoke housing 18 opposite the first opening of the yoke housing 18. The pawl 70 is provided within the yoke 42 and pivotably secured by a pin 78. The pin 78 is coupled to the rotational member 74, which has a gripping actuator 82 that is accessible through the yoke housing 18. A user may grasp and rotate the gripping actuator 82, and thereby move the pawl 70 between a first position corresponding to a first rotational locking direction 86a and a second position corresponding to a second rotational locking direction 86b of the output drive 34. In other embodiments, other types of forward/reverse switches may be used to move the pawl 70.

The illustrated pawl 70 includes an angled first end 90a and an angled second end 90b. Each end 90a, 90b of the pawl 70 has a plurality of teeth 94a, 94b that are configured to engage inner teeth 98 of the yoke 42. When the rotational member 74 is rotated to arrange the pawl 70 in the first position, the first end 90a of the pawl 70 meshes with the inner teeth 98 of the yoke 42. The first position thereby prevents the output drive 34 from rotating relative to the yoke 42 in the first direction 86a. In other words, the pawl 70 couples the output drive 34 for co-rotation with the yoke 42 in the first direction 86a. The teeth 94a on the first end 90a of the pawl 70 and/or the inner teeth 98 on the yoke 42 are angled to allow the teeth to slip past each other in the opposite direction 86b, thereby permitting the yoke 42 to “ratchet” and rotate relative to the output drive 34 in the second direction 86b. When the rotational member 74 is rotated to arrange the pawl 70 in the second position, the second end 90b of the pawl 70 meshes with the inner teeth 98 of the yoke 42. The second position thereby prevents the output drive 34 from rotating relative to the yoke 42 in the second direction 86b. In other words, the pawl 70 couples the output drive 34 for co-rotation with the yoke 42 in the second direction 86b. The teeth 94b on the second end 90b of the pawl 70 and/or the inner teeth 98 on the yoke 42 are angled to allow the teeth to slip past each other in the opposite direction 86a, thereby permitting the yoke 42 to “ratchet” and rotate relative to the output drive 34 in the first direction 86a.

With continued reference to FIGS. 2-4B, the powered ratchet tool 10 includes a barrier assembly 100 having a first barrier 102a and a second barrier 102b that are disposed between the yoke housing 18 and the yoke 42. The first and second barriers 102a, 102b are formed of a plastic material. In other embodiments, the first and second barriers 102a, 102b may formed of other suitable materials. Each barrier 102a, 102b includes a body 106a, 106b having a first end 110a, 110b and a second end 114a, 114b opposite the first end 110a, 110b. The first end 110a, 110b of each barrier 102a, 102b has circular cross-section and the second end 114a, 114b of each barrier 102a, 102b has a circular cross-section smaller than a corresponding first end 110a, 110b.

A first socket 118a is defined within the yoke 42 on a first side 122a of the ratchet tool 10 and a second socket 118b is defined within the yoke 42 on a second side 122b of the ratchet tool 10 opposite the first side 122a. Also, a first recess 126a is defined within the yoke housing 18 on the first side 122a of the ratchet tool 10 and a second recess 126b is defined within the yoke housing 18 on the second side 122b of the ratchet tool 10. The first socket 118a of the yoke 42 is disposed opposite the first recess 126a of the yoke housing 18. The second socket 118b of the yoke 42 is disposed opposite the second recess 126b of the yoke housing 18. As such, the first barrier 102a is disposed between the first socket 118a and the first recess 126a while the second barrier 102b is disposed between the second socket 118b and the second recess 126b.

More specifically, the first end 110a of the first barrier 102a is disposed within the first socket 118a to pivotably couple the first barrier 102a to the yoke 42 such that the first barrier 102a hinges back and forth during operation of the powered ratchet tool 10. The first end 110b of the second barrier 102b is disposed within the second socket 118b to pivotably couple the second barrier 102b to the yoke 42 such that the second barrier 102b also hinges back and forth. The second end 114a of the first barrier 102a is movably disposed within the first recess 126a of the yoke housing 18. The second end 114b of the second barrier 102b is movably disposed within the second recess 126b of the yoke housing 18. While the first and second barriers 102a, 102b pivot during operation, the barriers 102a, 102b are configured to seal a space 128 defined between the yoke housing 18 and the yoke 42. Moreover, the geometry of each recess 126a, 126b constrains the movement of a respective barrier 102a, 102b to maintain a sealed environment during operation.

In operation, a user engages the actuator to energize the motor 22 and rotate the output shaft 26. The rotation of the output shaft 26 is transferred to the ratchet mechanism 40 via the drive assembly 66. The drive assembly 66 drives rotation of the crankshaft 50 and the eccentric member 54 about the first axis 30, thereby rotating the drive bushing 58 to pivot the yoke 42 in a reciprocating manner relative to the yoke housing 18. The yoke 42 then transfers torque to the output drive 34 for rotation of the output drive 34 about the second axis 38 to either tighten or loosen a workpiece. The first and second barriers 102a, 102b also pivot in a reciprocating manner as the yoke 42 pivots to drive rotation of the output drive 34. More specifically, the body 106a, 106b of each barrier 102a, 102b pivots as the second end 114a, 114b of each barrier 102a, 102b moves within a respective recess 126a, 126b.

The first and second barriers 102a, 102b are disposed between the yoke housing 18 and the yoke 42 to provide ingress protection. As such, the barriers 102a, 102b prevent debris ingress within the location of the crankshaft 50. Also, the barriers 102a, 102b are configured to keep lubricating fluids (e.g., oil, grease, etc.) within the yoke 42. The first and second barriers 102a, 102b may be implemented into other ratchet tools such as a powered box ratchet.

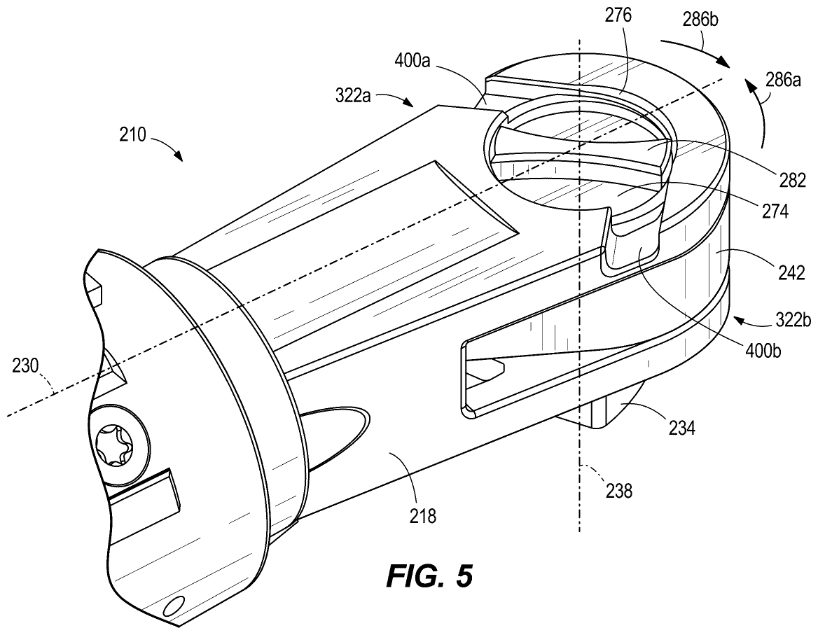

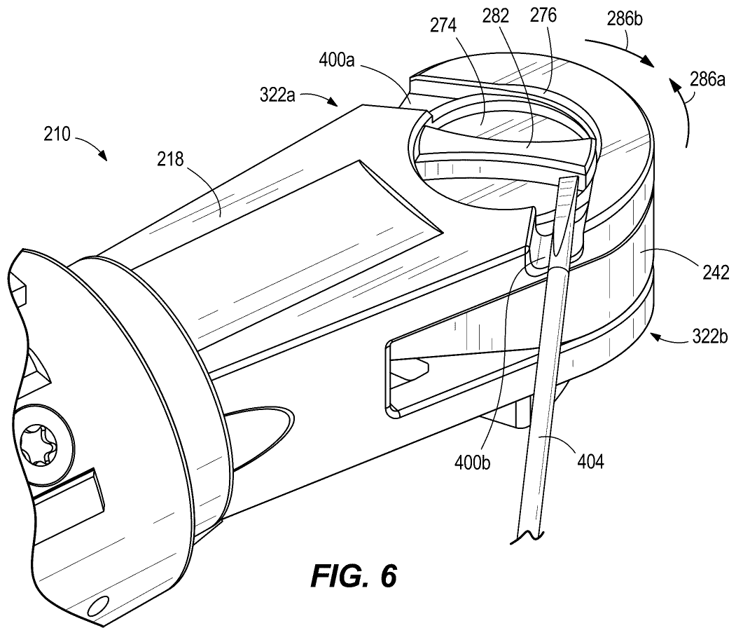

FIGS. 5 and 6 illustrate another a yoke housing 218 of a powered ratchet tool 210. The powered ratchet tool 210 is similar to the powered ratchet tool 10 of FIGS. 1-4B; therefore, like structure will be identified by like reference number plus “200” and only the differences will be discussed hereafter.

The yoke housing 218 includes a first cutout or groove 400a and a second cutout or groove 400b that are define within opposite sides 322a, 322b of the powered ratchet tool 210. The first and second grooves 400a, 400b are proximate the second opening 276 such that the grooves 400a, 400b communicate with the second opening 276. In the illustrated embodiment, the first and second grooves 400a, 400b are obliquely oriented relative to the first axis or the longitudinal axis 230 of the ratchet tool 210. Each groove 400a, 400b has a U-shaped cross-section. In other embodiments, the grooves 400a, 400b may have other cross-sectional shapes such as a rectangular-shaped cross-section.

The first groove 400a and the second groove 400b are configured to allow access to the gripping actuator 282 from a corresponding side 322a, 322b of the ratchet tool 210. A user may insert a tool element 404 through one of the grooves 400a, 400b to engage and rotate the gripping actuator 282. A pawl (not shown), disposed within the yoke 242, is moved by the gripping actuator 282 between a first position corresponding to a first rotational locking direction 286a and a second position corresponding to a second rotational locking direction 286b of the output drive 234. When the user inserts the tool element 404 through the first groove 400a (i.e., left groove of the yoke housing 218), the tool element 404 engages and rotates the gripping actuator 282 in a clockwise direction for reverse rotation (e.g., the first rotational locking direction 286a) of the output drive 234. When the user inserts the tool element 404 through the second groove (i.e., right groove of the yoke housing 218), then the tool element 404 engages and moves the gripping actuator 282 in a counterclockwise direction for forward rotation (e.g., the second rotational locking direction 286b) of the output drive 234.

When a user is operating the powered ratchet tool 210 in certain locations and positions, the gripping actuator 282 may not be accessible for changing the rotational locking direction 286a, 286b of the output drive 234. The first and second grooves 400a, 400b provides the user with an alternative option for changing the rotational locking direction 286a, 286b. As such, the user may insert the tool element 404 through a desired groove 400a, 400b to change the rotational locking direction 286a, 286b when the gripping actuator 282 is not accessible.

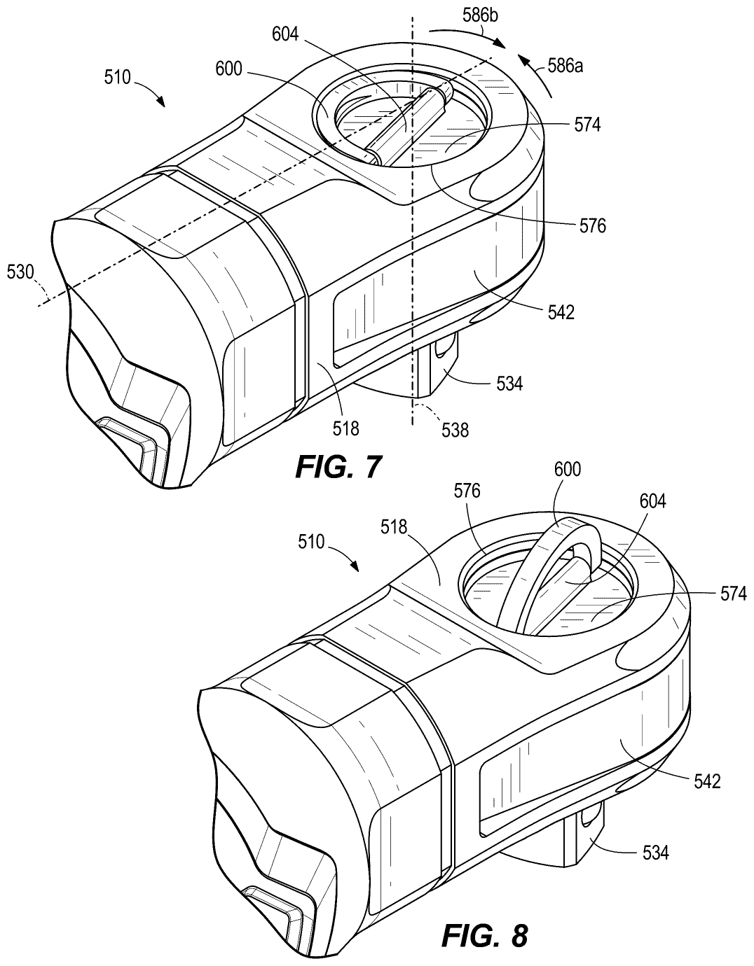

FIGS. 7 and 8 illustrate another a yoke housing 518 of a powered ratchet tool 510. The powered ratchet tool 510 is similar to the powered ratchet tool 10 of FIGS. 1-4B; therefore, like structure will be identified by like reference number plus “500” and only the differences will be discussed hereafter.

The powered ratchet tool 510 includes a lever 600 is pivotably coupled to a protrusion 604 integrally formed with and extending upward from the rotational member 574. The user may grasp and rotate the lever 600, and in turn, rotate the rotational member 574. A pawl (not shown), disposed within the yoke 542, is moved by rotation of the protrusion 604 between a first position corresponding to a first rotational locking direction 586a and a second position corresponding to a second rotational locking direction 586b of the output drive 534. The lever 600 forms a C-shape and is sized to conform with the configuration of the opening 576 defined in the yoke housing 518.

When the lever 600 is not being used, the lever 600 is positioned along the rotational member 574. In the illustrated embodiment, the lever 600 is flush with at least a portion of the yoke housing 518. In some embodiments, the lever 600 may have a low profile so that the lever 600 is positioned below at least a portion of the yoke housing 518. In other embodiments, the lever 600 may be configured such that the lever 600 extends beyond at least a portion of the yoke housing 218. When the user has the desire to change the position of the protrusion 604, the user may pivot the lever 600 relative to the protrusion 604 and thereby raise the lever 600 to permit rotation of the lever 600. As such, the lever 600 is a low-profile design that provides an easy process for changing the rotational locking direction 586a, 586b of the output drive 534.

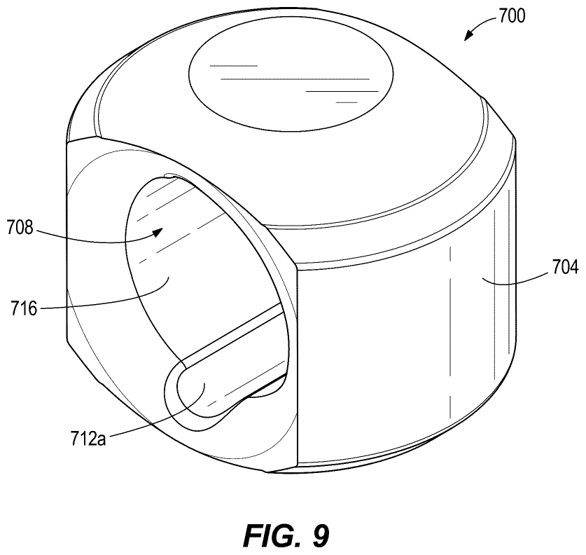

FIGS. 8 and 9 illustrate another drive bushing 700 that may be incorporated in the powered ratchet tool 10 of FIGS. 1-4B, the powered ratchet tool 210 of FIGS. 5 and 6, and the powered ratchet tool 510 of FIGS. 7 and 8. The drive bushing 700 includes a body 704 and a bore 708 defined through the body 704 such that the drive bushing 700 is configured to receive an eccentric member (not shown) of a crankshaft (not shown).

The drive bushing 700 further includes a first groove 712a and a second groove 712b defined within an interior surface 716 of the bore 708. In the illustrated embodiment, the first groove 712a is arranged at a bottom portion of the body 704 and the second groove 712b is arranged at a top portion of the bore 708. As such, the first and second grooves 712a, 712b are arranged opposite of each other. In other embodiments, the first and second grooves 712a, 712b may be defined at any location along the interior surface 716 of the bore 708. The first and second grooves 712a, 712b are defined within the drive bushing 700 to allow for storage of grease within the drive bushing 700 to reduce wear during lifetime of the powered ratchet tool 10, 210, 510. Since the grooves 712a, 712b are oriented at the top portion and the bottom portion of the body 704 of the drive bushing 700, additional grease is permitted to be added without total disassembly of the tool 10, 210, 510.

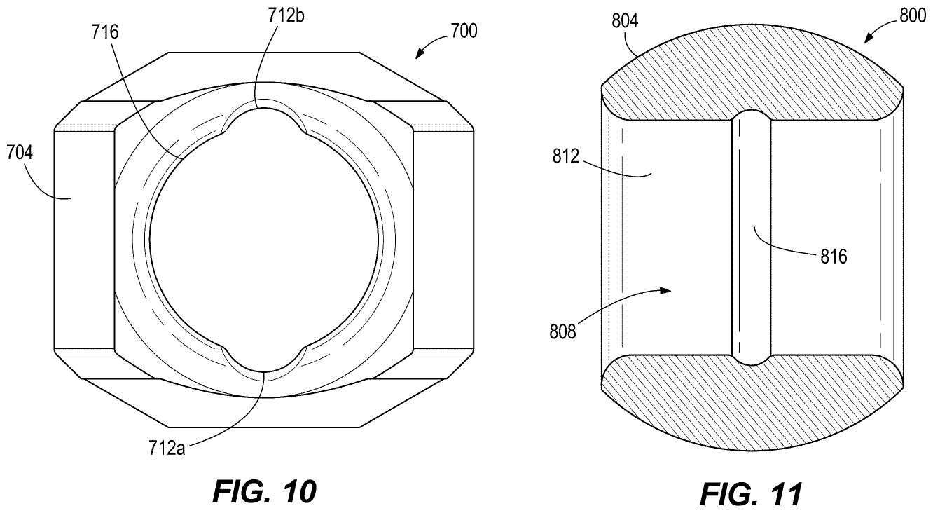

FIG. 11 illustrates another drive bushing 800 that may be incorporated in the powered ratchet tool 10 of FIGS. 1-4B, the powered ratchet tool 210 of FIGS. 5 and 6, and the powered ratchet tool 510 of FIGS. 7 and 8. The drive bushing 800 is similar to the drive bushing 700 of FIGS. 9 and 10; therefore, like structure will be identified by like reference number plus “100” and only the differences will be discussed hereafter.

The drive bushing 800 includes a body 804 and a bore 808 defined through the body 804. A groove 812 is centrally defined within an interior surface 816 of the bore 808. As such, the groove 812 is configured to allow for storage of grease within the drive bushing 800 to reduce wear during lifetime of the powered ratchet tool 10, 210, 510.

Although the disclosure has been described in detail with reference to certain preferred embodiments, variations and modifications exist within the scope and spirit of one or more independent aspects of the disclosure as described.

Various features and aspects of the present disclosure are set forth in the following claims.

What is claimed is:

1. A powered ratchet tool comprising:
a housing;
a motor disposed within the housing, the motor including an output shaft rotatable about a first axis;
a ratchet mechanism operably coupled to the output shaft of the motor to be driven by the motor, the ratchet mechanism including a yoke supported by the housing for reciprocation about a second axis perpendicular to the first axis;
a barrier assembly pivotably disposed between the housing and the yoke, the barrier assembly configured to seal a space defined between the housing and the yoke; and
an output drive configured to receive a tool element, the output drive coupled to the yoke of the ratchet mechanism for rotation about the second axis.

2. The powered ratchet tool of claim 1, wherein the barrier assembly is pivotably coupled to the yoke and configured to reciprocate within the housing as the yoke reciprocates about the second axis.

3. The powered ratchet tool of claim 2, wherein the housing includes a handle housing and a yoke housing coupled to and extending from the handle housing, the yoke housing configured to support the yoke of the ratchet mechanism, and wherein the barrier assembly is configured to reciprocate within the yoke housing as the yoke reciprocates about the second axis.

4. The powered ratchet tool of claim 1, wherein the barrier assembly includes a first barrier having a first end pivotably coupled to the yoke and a second end disposed within the housing, and a second barrier having a first end pivotably coupled to the yoke and a second end disposed within the housing, and wherein the first barrier is disposed on a first side of the housing and the second barrier is disposed on a second side of the housing opposite the first side.

5. The powered ratchet tool of claim 4, wherein the second end of the first barrier is movably disposed within a first recess defined in the first side of the housing and the second end of the second barrier is movably disposed within a second recess defined in the second side of the housing.

6. The powered ratchet tool of claim 1, wherein the ratchet mechanism further includes
a crankshaft operably coupled to the output shaft of the motor, the crankshaft having an eccentric member, and
a drive bushing arranged on the eccentric member, and
wherein the drive bushing is arranged in the yoke.

7. The powered ratchet tool of claim 6, wherein the drive bushing includes an internal groove for storage of grease within the drive bushing.

8. A powered ratchet tool comprising:
a housing defining a longitudinal axis;
a motor disposed within the housing;
a ratchet mechanism operably coupled to the motor, the ratchet mechanism including a yoke rotatable about a second axis perpendicular to the longitudinal axis when driven by the motor;
an output drive extending through the housing to be coupled to the yoke for co-rotation;
a rotational member coupled to the output drive, the rotational member rotatable between a first position, in which the output drive co-rotates with the yoke in a first direction, and a second position, in which the output drive co-rotates with the yoke in a second direction opposite the first direction;
a first groove defined within the housing, the first groove configured to provide access to the rotational member from a first side of the housing to rotate the rotational member; and
a second groove defined within the housing, the second groove configured to provide access to the rotational member from a second side of the housing opposite the first side to rotate the rotational member.

9. The powered ratchet tool of claim 8, wherein the first groove and the second groove have a U-shaped cross-section.

10. The powered ratchet tool of claim 8, wherein the first groove and the second groove are obliquely oriented relative the longitudinal axis of the housing.

11. The powered ratchet tool of claim 8, wherein the housing defines an opening in which the rotational member is arranged, and wherein the first groove and the second groove communicate with the opening to provide access to the rotational member from the first side and the second side of the housing.

12. The powered ratchet tool of claim 8, wherein the first direction defines a forward rotational direction and the second direction defines a reverse rotational direction.

13. The powered ratchet tool of claim 12, wherein the first groove is configured to receive a tool element to rotate the rotational member from the first position to the second position, and wherein the second groove is configured to receive the tool element to rotate the rotational member from the second position to the first position.

14. The powered ratchet tool of claim 8, wherein the ratchet mechanism further includes
a crankshaft operably coupled to the motor, the crankshaft having an eccentric member, and
a drive bushing arranged on the eccentric member, and
wherein the drive bushing is arranged in the yoke.

15. The powered ratchet tool of claim 14, wherein the drive bushing has an internal groove for storage of grease within the drive bushing.

16. A powered ratchet tool comprising:
a housing defining a longitudinal axis;
a motor disposed within the housing;
a ratchet mechanism operably coupled to the motor, the ratchet mechanism including a yoke supported by the housing for reciprocation about a second axis perpendicular to the longitudinal axis;
an output drive extending through the housing to be coupled to the yoke for co-rotation;
a rotational member coupled to the output drive, the rotational member rotatable between a first position, in which the output drive co-rotates with the yoke in a first direction, and a second position, in which the output drive co-rotates with the yoke in a second direction opposite the first direction; and
a lever pivotably coupled to the rotational member and configured to be grasped to facilitate rotation of the rotational member between the first position and the second position.

17. The powered ratchet tool of claim 16, wherein the lever is pivotable between a lowered position, in which the lever extends along the rotational member, and a raised position, in which the lever extends outwardly from the rotational member.

18. The powered ratchet tool of claim 17, wherein the lever extends beyond a surrounding wall of the housing when in the raised position.

19. The powered ratchet tool of claim 18, wherein the lever is recessed below the surrounding wall of the housing when in the lowered position.

20. The powered ratchet tool of claim 16, wherein the rotational member has a protrusion extending therefrom, and wherein the lever is pivotably coupled to the protrusion.
